(19) United States
(12) Patent Application Publication
(10) Pub. No.: US 2026/0235213 A1
(43) Pub. Date: Aug. 13, 2026

(54) CONTROL VALVE

(71) Applicant: YAMADA MANUFACTURING CO., LTD., Gunma (JP)

(72) Inventor: Akifumi Ozeki, Kiryu-shi, Gunma (JP)

(21) Appl. No.: 19/155,404

(22) PCT Filed: Jan. 24, 2024
(86) PCT No.: PCT/JP2024/002042

§ 371 Date: Aug. 11, 2025

(30) Foreign Application Priority Data
Mar. 14, 2023 (JP) 2023-039655

(51) Int. Cl. F16K 11/083

(52) U.S. Cl. CPC F16K 11/0836

(57) ABSTRACT

A control valve according to an aspect of the present disclosure includes a casing in which a flow inlet and a flow outlet are formed, and a rotor including a shaft portion that is located on a first side in an axial direction and that is rotatably supported by the casing, and a valve body that forms an internal space that is open toward a second side in the axial direction. The rotor switches between communication and shut-off between the internal space and at least one of the flow inlet and the flow outlet, through a communication port formed in the valve body, in accordance with a rotation position of the rotor, in a state in which an outer peripheral surface of the valve body is supported to be slidable on a support surface formed on the casing. A first biasing member that biases the rotor toward the first side in the axial direction is provided inside the rotor.

### TECHNICAL FIELD

The present disclosure relates to a control valve.

Priority is claimed on Japanese Patent Application No. 2023-039655, filed Mar. 14, 2023, the content of which is incorporated herein by reference.

### BACKGROUND ART

A cooling system is mounted in a vehicle. The cooling system cools a heat generating portion by means of a cooling liquid that circulates between the heat generating portion (for example, an engine, a motor, or the like) and a heat dissipating portion (for example, a radiator, a heater, or the like). In the cooling system, flow of the cooling liquid is controlled by a control valve provided in a flow path connecting the heat generating portion and the heat dissipating portion.

Further size reduction is being considered for the control valve. For example, Patent Document 1 discloses a configuration in which a first opening portion and a second opening portion are disposed in parallel in an axial direction of a valve body. In Patent Document 1, a third opening portion is disposed at a circumferentially different position in the valve body from the first opening portion and the second opening portion such that at least a part of the first opening portion and at least a part of the second opening portion overlap with the third opening portion.

### CITATION LIST

### Patent Document

Patent Document 1: Japanese Unexamined Patent Application, First Publication No. 2015-59615

### SUMMARY OF INVENTION

### Technical Problem

However, in the related art, for each opening portion, it is necessary to provide a sealing mechanism, for example, between a port and the opening portion. Therefore, in the related art, there has still been room for improvement in terms of reduction in the number of components and cost reduction.

The present disclosure provides a control valve capable of achieving reduction in the number of components and cost reduction.

### Solution to Problem

In order to achieve the above-described object, the present disclosure has employed the following aspect.
(1) According to one aspect of the present disclosure, there is provided a control valve including: a casing in which a flow inlet through which a fluid flows in from an outside and a flow outlet through which the fluid flows out to the outside are formed; and a rotor including a shaft portion located on a first side in an axial direction and rotatably supported by the casing, and a valve body having an outer diameter that gradually increases toward a second side in the axial direction from the shaft portion and forming an internal space that is open toward the second side in the axial direction, in which the rotor switches between communication and shut-off between the internal space and at least one of the flow inlet and the first flow outlet, through a communication port formed in the valve body, in accordance with a rotation position of the rotor, in a state in which an outer peripheral surface of the valve body is supported to be slidable on a support surface formed on the casing, and a first biasing member configured to bias the rotor toward the first side in the axial direction is provided inside the rotor.

According to the present aspect, since the outer peripheral surface of the valve body is directly supported by the support surface of the casing, it is not necessary to separately provide a sealing member or a bearing. Therefore, it is possible to achieve reductions in the number of components and assembly man-hours, size reduction of the control valve, and cost reduction.

Since the valve body is formed in a tapered shape, in a case where the outer diameter of the rotor expands or contracts due to heat, the rotor is displaced in the axial direction with respect to the casing in response to an increase or decrease in the outer diameter. Therefore, the valve body is stably supported by the casing regardless of the expansion and contraction change of the rotor. Accordingly, the operational stability of the control valve can be ensured.

According to the present aspect, since the first biasing member that biases the rotor toward the first side in the axial direction is provided inside the rotor, the outer peripheral surface of the valve body can be pressed against the support surface. Therefore, sealing performance between the outer peripheral surface of the valve body and the support surface can be ensured. As a result, it is possible to suppress unexpected leakage of a cooling liquid from a gap between the outer peripheral surface of the valve body and the support surface, and to allow a desired flow rate of the cooling liquid to flow. In addition, since the biasing member is provided inside the rotor, it is possible to achieve size reduction of the control valve in the axial direction as compared with a case where the biasing member is provided outside the rotor.

(2) In the control valve according to the aspect (1), it is preferable that the casing includes an opposing wall facing a second side opening portion of the valve body in the axial direction, the first biasing member is a coil spring extending in the axial direction, and the first biasing member is interposed between the opposing wall and an inner surface of the rotor through the internal space.
According to the present aspect, the outer peripheral surface of the valve body can be stably pressed against the support surface. As a result, sealing performance between the outer peripheral surface of the valve body and the support surface can be ensured.

(3) In the control valve according to the aspect (2), it is preferable that the valve body includes a valve bottom wall projecting from the shaft portion in a radial direction intersecting the axial direction, and a sliding wall having an outer diameter that gradually increases toward the second side in the axial direction, the sliding wall being continuous with an outer peripheral edge of the valve bottom wall, and a first side end portion of the first biasing member in the axial direction is supported by the valve bottom wall.
According to the present aspect, the first side end portion of the first biasing member can be stably supported.

(4) In the control valve according to the aspect (3), it is preferable that the shaft portion includes a first support portion protruding to the second side in the axial direction beyond the valve bottom wall and configured to support, in the radial direction intersecting the axial direction, the first side end portion of the first biasing member in the axial direction. According to the present aspect, the movement of the first biasing member in the radial direction with respect to the valve body can be restricted. As a result, a stable biasing force can be exhibited over a long period of time.

(5) In the control valve according to any one of (2) to (4), it is preferable that the opposing wall is provided with a second support portion extending into the internal space through the second side opening portion of the valve body and configured to support, in the radial direction intersecting the axial direction, a second side end portion of the first biasing member in the axial direction.

According to the present aspect, the movement of the first biasing member in the radial direction with respect to the opposing wall can be restricted. As a result, a stable biasing force can be exhibited over a long period of time.

(6) In the control valve according to any one of (1) to (5), it is preferable that the shaft portion is formed with a recessed portion communicating with the internal space, the recessed portion being open toward the second side in the axial direction.
According to the present aspect, it is possible to suppress an increase in the wall thickness of the shaft portion when forming the rotor by injection molding.
   Consequently, it is possible to suppress sink marks and the like in the shaft portion and to mold the shaft portion with high accuracy. As a result, the rotor can be stably rotated. Since the recessed portion is formed to be recessed with respect to the internal space, the recessed portion serves as a stagnation point inside the rotor. Therefore, for example, contaminants and the like in the cooling liquid can be captured in the recessed portion. As a result, it is possible to suppress biting of contaminants and the like between the outer peripheral surface of the valve body and the support surface.

(7) In the control valve according to the aspect (6), it is preferable that the shaft portion includes a transmission portion penetrating the casing in the axial direction through a through-hole formed in the casing, and a coupling portion continuous with the transmission portion on the first side in the axial direction and coupled to an actuator, a seal ring configured to seal an inside and an outside of the casing is formed between the transmission portion and an inner peripheral surface of the through-hole, and the recessed portion is formed in at least the transmission portion.
According to the present aspect, it is possible to suppress sink marks and the like in the transmission portion and to mold the transmission portion with high accuracy. As a result, sealing performance between the seal ring and the transmission portion can be improved.

(8) In the control valve according to the aspect (1), it is preferable that the first biasing member is one member of a magnet and a ferromagnetic member attractable to the magnet, and the casing is provided with a second biasing member formed of the other member of the magnet and the ferromagnetic member.
According to the present aspect, the valve body is pressed against the support surface by the biasing force (magnetic force) generated between the first biasing member and the second biasing member, whereby sealing performance between the outer peripheral surface of the valve body and the support surface can be ensured.
Moreover, since the biasing member does not cross an inner space of the rotor in the axial direction, pressure loss in the internal space can be reduced.

### Advantageous Effects of Invention

According to one aspect of the present disclosure, it is possible to achieve a reduction in the number of components and cost reduction.

### BRIEF DESCRIPTION OF DRAWINGS

FIG. 1 A block diagram of a cooling system according to an embodiment.

FIG. 2 A perspective view of a control valve according to a first embodiment.

FIG. 3 An exploded perspective view of the control valve according to the first embodiment.

FIG. 4 A cross-sectional view corresponding to line IV-IV of FIG. 2.

FIG. 5 A cross-sectional view corresponding to line V-V of FIG. 2.

FIG. 6 An enlarged view of a portion VI of FIG. 4.

FIG. 7 A bottom view of a cover according to the first embodiment.

FIG. 8 A plan view of the control valve (in a first communication state) shown through the cover according to the first embodiment.

FIG. 9 A plan view of the control valve (in a second communication state) shown through the cover according to the first embodiment.

FIG. 10 An enlarged cross-sectional view according to a second embodiment that corresponds to FIG. 6.

FIG. 11 A plan view of a rotor according to a modification example.

### DESCRIPTION OF EMBODIMENTS

Next, embodiments of the present disclosure will be described with reference to the drawings. In the embodiments and modification examples, which will be described below, corresponding configurations may be denoted by the same reference numerals, and descriptions thereof may not be repeated. In the following description, for example, expressions indicating relative or absolute dispositions such as “parallel”, “orthogonal”, “center”, and “coaxial” not only strictly represent such dispositions but also represent a state in which components are relatively displaced with angles and distances that allow for tolerances or to a degree that the same function can be obtained. In the present embodiment, “facing” is not limited to a case where orthogonal directions (normal directions) of two surfaces coincide with each other but also includes a case where the orthogonal directions intersect each other.

### Cooling System 1

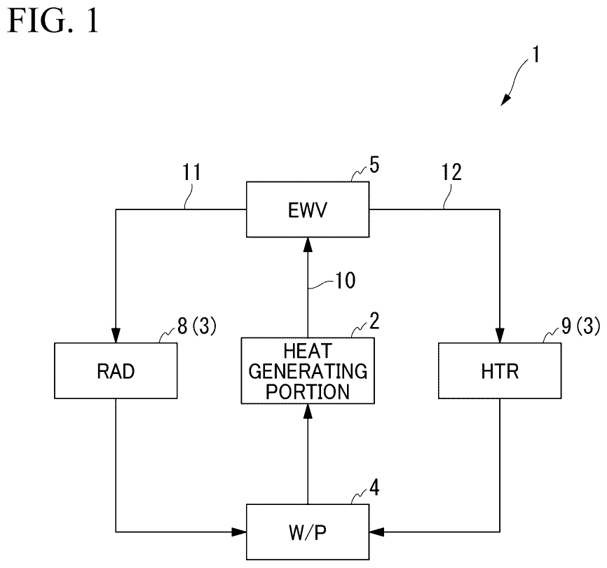

FIG. 1 is a block diagram of a cooling system 1.
As shown in FIG. 1, the cooling system 1 is mounted in, for example, a vehicle. In the present embodiment, the vehicle is not limited to a vehicle provided with an engine (internal combustion engine) as a vehicle drive source and may be an electrified vehicle. The electrified vehicle includes an electric vehicle, a hybrid vehicle, a plug-in hybrid vehicle, a fuel cell vehicle, and the like.

The cooling system 1 includes a heat generating portion 2, a heat dissipating portion 3, a water pump 4 (W/P), and a control valve 5 (EWV). In the cooling system 1, a cooling liquid circulates between the heat generating portion 2 and the heat dissipating portion 3 by operations of the water pump 4 and the control valve 5.

The heat generating portion 2 is a component to be cooled by the cooling liquid (a component from which the cooling liquid absorbs heat) and is a drive source of the vehicle or another heat generating component. In a case of the electrified vehicle, examples of the heat generating portion 2 include a drive motor, a battery, a power conversion device, and the like.
The heat dissipating portion 3 is a component that serves as a target for heat dissipation by the cooling liquid. In the present embodiment, as the heat dissipating portion 3, a radiator 8 (RAD) and a heater core 9 (HTR) are provided. The heat dissipating portion 3 can be selected as appropriate as long as it is a member whose temperature during a normal operation is lower than the temperature of the cooling liquid after passing through the heat generating portion 2. As such a component, the heat dissipating portion 3 may be, for example, an EGR cooler, a heat exchanger, or the like. The EGR cooler performs heat exchange between EGR gas and the cooling liquid. The heat exchanger performs heat exchange between lubricating oil and the cooling liquid.

The water pump 4, the heat generating portion 2, and the control valve 5 are sequentially connected from upstream to downstream on a main flow path 10. In the main flow path 10, the cooling liquid sequentially passes through the heat generating portion 2 and the control valve 5 by the operation of the water pump 4.

A radiator flow path 11 and an air conditioning flow path 12 are each connected to the main flow path 10.
The radiator flow path 11 is provided with the radiator 8. The radiator flow path 11 is connected to the control valve 5 at a portion located upstream of the radiator 8. The radiator flow path 11 is connected to the heat generating portion 2 at a portion located downstream of the radiator 8. In the radiator flow path 11, heat exchange between the cooling liquid and outside air is performed in the radiator 8.

The air conditioning flow path 12 is provided with the heater core 9. The air conditioning flow path 12 is connected to the control valve 5 at a portion located upstream of the heater core 9. The air conditioning flow path 12 is connected to the heat generating portion 2 at a portion located downstream of the heater core 9. The heater core 9 is provided, for example, in a duct (not shown) of an air conditioning device. In the air conditioning flow path 12, heat exchange is performed in the heater core 9 between the cooling liquid and air conditioning air flowing inside the duct.

In the cooling system 1, the cooling liquid that has flowed into the control valve 5 by the operation of the water pump 4 is selectively supplied to at least one of the heat dissipating portions 3 by the operation of the control valve 5. The cooling liquid supplied to the heat dissipating portion 3 undergoes heat exchange with the heat dissipating portion 3 in the process of passing through the heat dissipating portion 3. Consequently, the cooling liquid is cooled by the heat dissipating portion 3. The cooling liquid that has passed through the heat dissipating portion 3 is supplied to the heat generating portion 2, and then undergoes heat exchange with the heat generating portion 2 in the process of passing through the heat generating portion 2. Consequently, the heat generating portion 2 is cooled by the cooling liquid. In this manner, in the cooling system 1, the heat generating portion 2 is cooled by the cooling liquid while the cooling liquid is cooled by the heat dissipating portion 3 in the process of circulating the cooling liquid between the heat generating portion 2 and the heat dissipating portion 3. As a result, in the cooling system 1, it is possible to control the heat generating portion 2 to a desired temperature.

### First Embodiment

### Control Valve 5

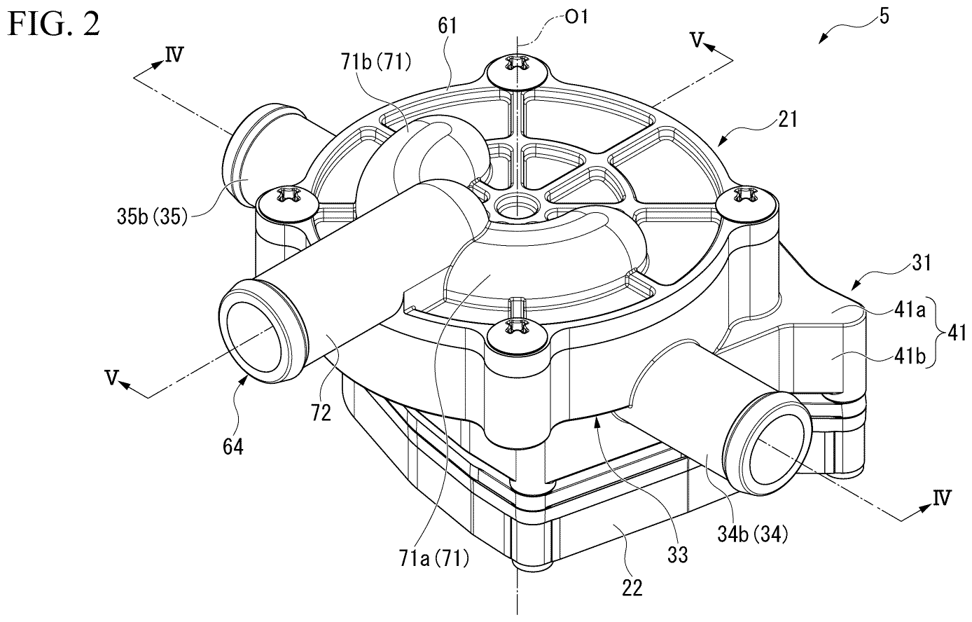

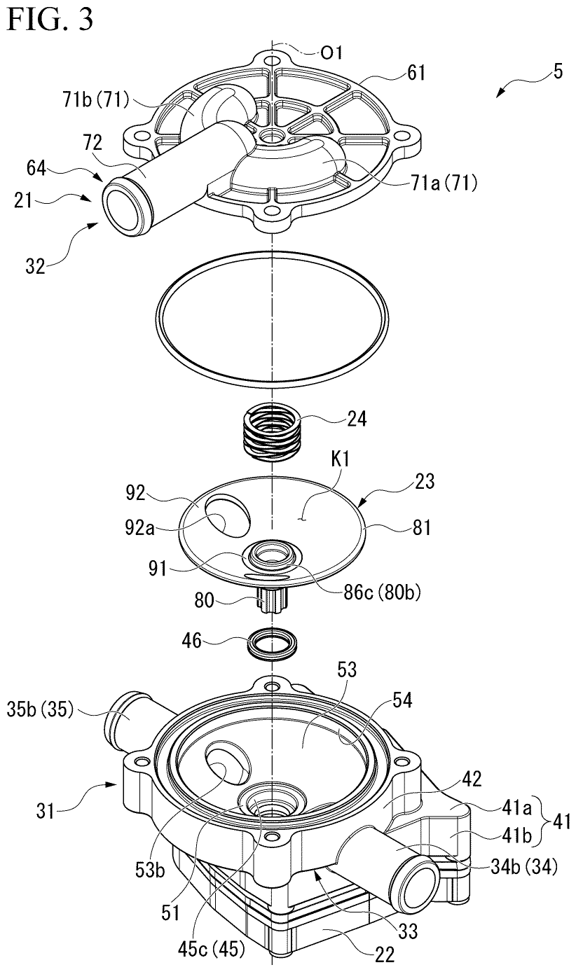

FIG. 2 is a perspective view of the control valve 5, FIG. 3 is an exploded perspective view of the control valve 5 ..
As shown in FIGS. 2 and 3, the control valve 5 includes a casing 21, a drive unit 22, a rotor 23, and a biasing member 24.

### Casing 21

The casing 21 includes a casing main body 31 and a cover 32. In the following description, a direction along a central axis O1 of the rotor 23 will be referred to simply as an axial direction. In the axial direction, a drive unit 22 side is defined as a lower side (first side), and a cover 32 side is defined as an upper side (second side). A direction intersecting the central axis Ol as seen from the axial direction will be referred to as a radial direction, and a direction around the central axis O1 will be referred to as a circumferential direction.

### Casing Main Body 31

The casing main body 31 includes a base portion 33, a first outflow port 34, and a second outflow port 35. The base portion 33, the first outflow port 34, and the second outflow port 35 are integrally formed by, for example, injection-molding a resin material.
The base portion 33 is formed in a bottomed cylindrical shape that is open upward. Specifically, the base portion 33 includes a mounting base 41 and a rotor housing portion 42.

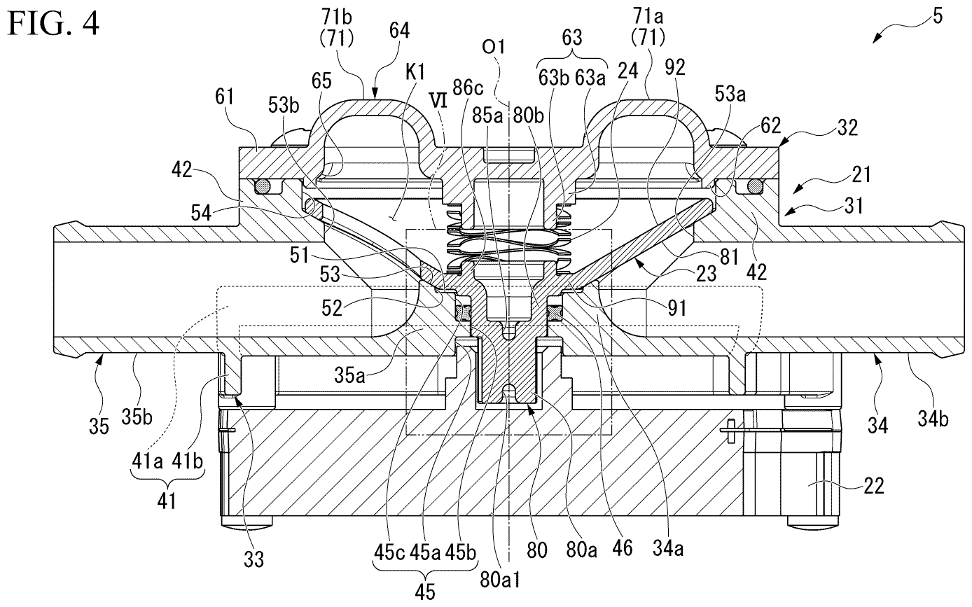

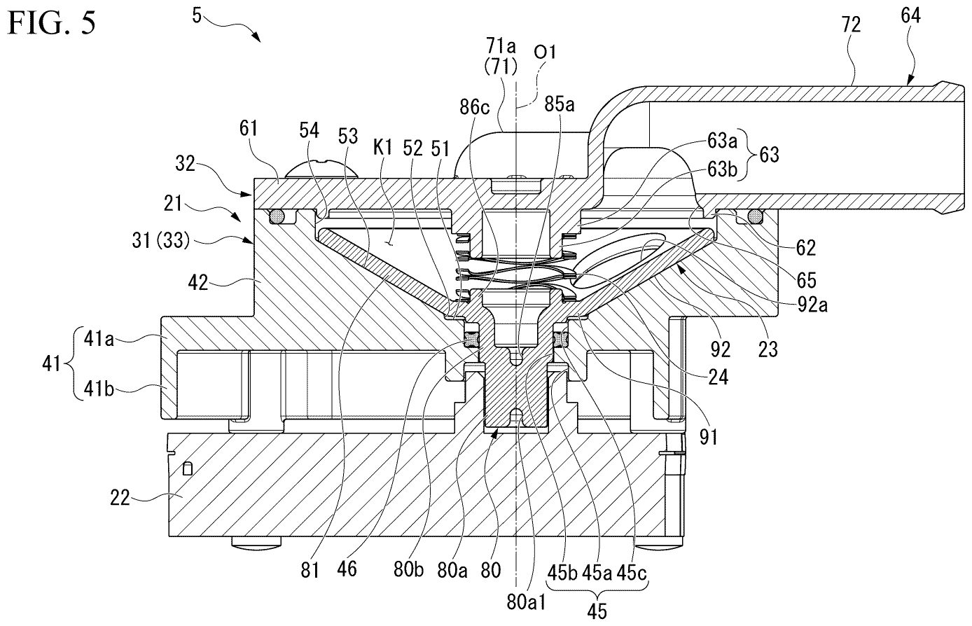

FIG. 4 is a cross-sectional view corresponding to line IV-IV of FIG. 2. FIG. 5 is a cross-sectional view corresponding to line V-V of FIG. 2.
As shown in FIGS. 4 and 5, the mounting base 41 is a portion on which the drive unit 22 is mounted. The mounting base 41 includes a partition wall 41a and an upright wall 41b. The partition wall 41a is formed to have a size such that it projects radially outward beyond the rotor housing portion 42 in plan view as seen from the axial direction. The upright wall 41b extends downward from an outer peripheral edge of the partition wall 41a.

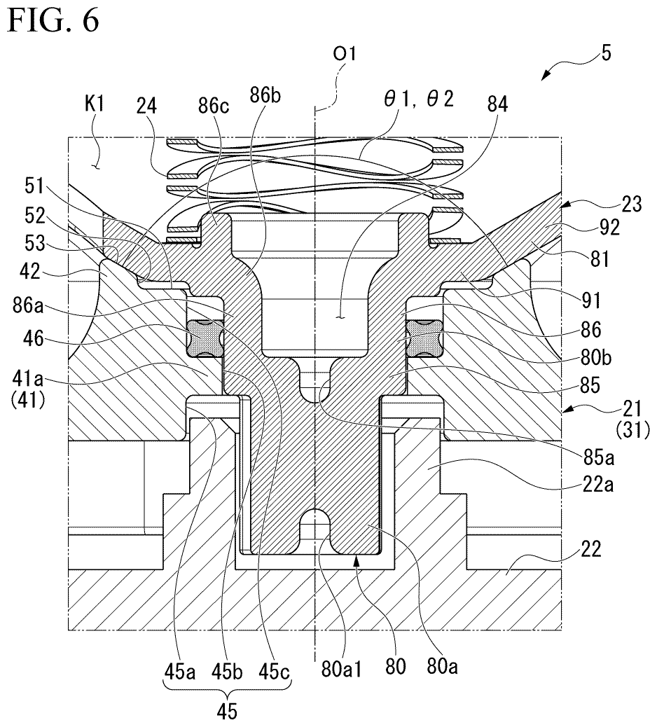

FIG. 6 is an enlarged view of a portion VI of FIG. 4.
As shown in FIG. 6, a through-hole 45 that penetrates the partition wall 41a in the axial direction is formed in a portion of the partition wall 41a that is located on the central axis O1. The through-hole 45 is formed in a stepped shape. An inner diameter of the through-hole 45 that is located at a central part in the axial direction is smaller than inner diameters of an upper end portion and a lower end portion. Specifically, the through-hole 45 includes a first large-diameter portion 45a located at a lower side, a small-diameter portion 45b that is continuous with and extends upward from the first large-diameter portion 45a, and a second large-diameter portion 45c that is continuous with and extends upward from the small-diameter portion 45b. In the example shown in the drawing, the inner diameters of the first large-diameter portion 45a and the second large-diameter portion 45c are equal to each other. A seal ring 46, such as an X-ring, is housed in the second large-diameter portion 45c. The seal ring 46 is in proximity to or in contact with a bottom surface of the second large-diameter portion 45c in a state of being fitted into an inner peripheral surface of the second large-diameter portion 45c.

An inner diameter of the seal ring 46 is equal to the inner diameter of the small-diameter portion 45b.

As shown in FIGS. 4 and 5, the rotor housing portion 42 is a portion that houses the rotor 23, The rotor housing portion 42 is formed in a cylindrical shape extending upward from the partition wall 41a. A lower end opening portion of the rotor housing portion 42 is closed by the partition wall 41a. The rotor housing portion 42 gradually increases in inner diameter from the lower side toward the upper side. Specifically, an inner peripheral surface of the rotor housing portion 42 includes a relief surface 51, a transition surface 52, a support surface 53, and a positioning surface 54.

The relief surface 51 extends radially outward from an upper end opening edge of the through-hole 45 (second large-diameter portion 45c). The relief surface 51 is formed as a flat surface orthogonal to the axial direction.
The transition surface 52 extends upward from an outer peripheral edge of the relief surface 51. The transition surface 52 is a cylindrical surface coaxial with the central axis O1. The transition surface 52 surrounds the relief surface 51 over the entire circumference.

The support surface 53 is continuous with the entire circumference of an upper end edge of the transition surface 52. The support surface 53 is a tapered surface that extends radially outward from the lower side toward the upper side. In cross-sectional view along the axial direction, the support surface 53 linearly extends. In cross-sectional view along the axial direction, an angle θ1 (a taper angle shown in FIG. 6) formed by portions of the support surface 53 that face each other in the radial direction is preferably 90°<θ1<180° and more preferably 110°<θ1<160°. In cross-sectional view along the axial direction, the support surface 53 is formed symmetrically with respect to the central axis O1.

The positioning surface 54 extends upward from an upper end edge of the support surface 53. The positioning surface 54 is a cylindrical surface coaxial with the central axis O1. The positioning surface 54 surrounds the support surface 53 over the entire circumference.

As shown in FIG. 4, a first flow outlet 53a and a second flow outlet 53b are open on the support surface 53 of the rotor housing portion 42. Each of the flow outlets 53a and 53b is open upward (to the second side in the axial direction) on the support surface 53. The flow outlets 53a and 53b are formed on the same circumference (at the same height in the axial direction) and are positioned 180°apart from each other in the circumferential direction. The flow outlets 53a and 53b face each other in a first direction (opposing direction) in the radial direction. It is preferable that an opening edge (a boundary portion with the support surface 53) of each of the flow outlets 53a and 53b is formed in a curved shape. Inner diameters of the flow outlets 53a and 53b are equal to each other. However, a position, a size, and the like of each of the flow outlets 53a and 53b can be changed as appropriate.

The first outflow port 34 connects, for example, the radiator flow path 11 and the control valve 5. The first outflow port 34 is integrally formed with the base portion 33. The first outflow port 34 is formed in an L-shaped tubular shape in cross-sectional view along the axial direction. Specifically, the first outflow port 34 includes a lead-out portion 34a located on the upstream side and a joint portion 34b continuous with the lead-out portion 34a on the downstream side.

The lead-out portion 34a extends downward from the opening edge of the first flow outlet 53a. The first outflow port 34 is in communication with the first flow outlet 53a through the lead-out portion 34a. A lower end of the lead-out portion 34a is located between a lower surface of the partition wall 41a and a lower end edge of the upright wall 41b.

The joint portion 34b extends outward in the first direction from the lower end of the lead-out portion 34a. An outer end portion of the joint portion 34b in the first direction protrudes outward beyond the base portion 33. For example, the radiator flow path 11 is connected to the outer end portion of the joint portion 34b.

The second outflow port 35 connects, for example, the air conditioning flow path 12 and the control valve 5. The second outflow port 35 is integrally formed with the base portion 33. The second outflow port 35 is formed to be symmetrical with the first outflow port 34 in the first direction with the central axis O1 as a symmetry axis. Specifically, the second outflow port 35 includes a lead-out portion 35a located on the upstream side and a joint portion 35b continuous with the lead-out portion 35a on the downstream side.

The lead-out portion 35a extends downward from the opening edge of the second flow outlet 53b. The second outflow port 35 is in communication with the second flow outlet 53b through the lead-out portion 35a. A lower end of the lead-out portion 35a is located between the lower surface of the partition wall 41a and the lower end edge of the upright wall 41b.
The joint portion 35b extends outward in the first direction from the lower end of the lead-out portion 35a. The outflow ports 34 and 35 are linearly aligned in the first direction. An outer end portion of the joint portion 35b in the first direction protrudes outward beyond the base portion 33. For example, the air conditioning flow path 12 is connected to the outer end portion of the joint portion 35b.

### Cover 32

As shown in FIGS. 3 to 5, the cover 32 closes an upper end opening portion (second side opening portion) of the base portion 33 (rotor housing portion 42). Specifically, the cover 32 includes an opposing wall 61, a positioning portion 62, a spring support portion 63, and an inflow port 64. The opposing wall 61, the positioning portion 62, the spring support portion 63, and the inflow port 64 are integrally formed by, for example, injection molding a resin material.
The opposing wall 61 is formed in a plate shape having the axial direction as a thickness direction. The outer shape of the opposing wall 61 in plan view is formed to be the same as the outer shape of the rotor housing portion 42 in plan view. The opposing wall 61 is assembled to the rotor housing portion 42 in a state of being overlaid on an upper surface of the rotor housing portion 42. Consequently, the upper end opening portion of the base portion 33 is closed by the cover 32. A gasket such as an O-ring is interposed between the opposing wall 61 and the base portion 33 (rotor housing portion 42).

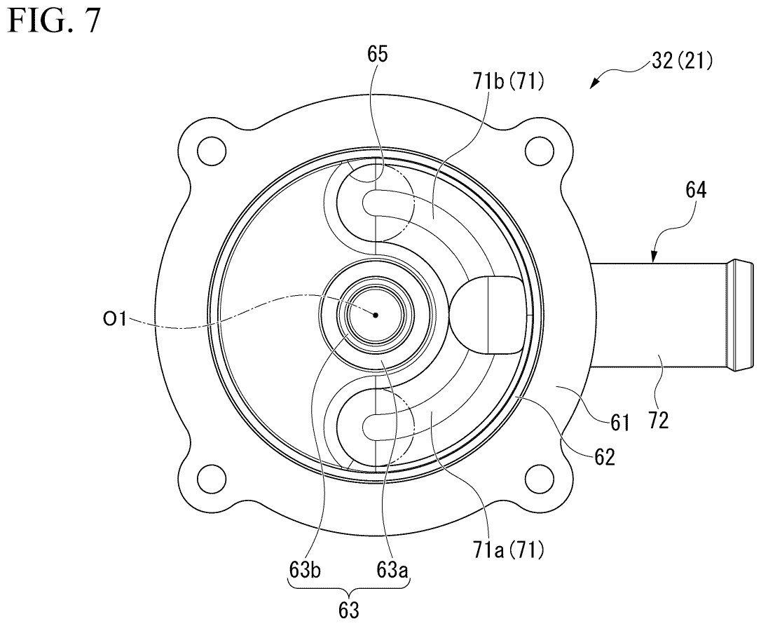

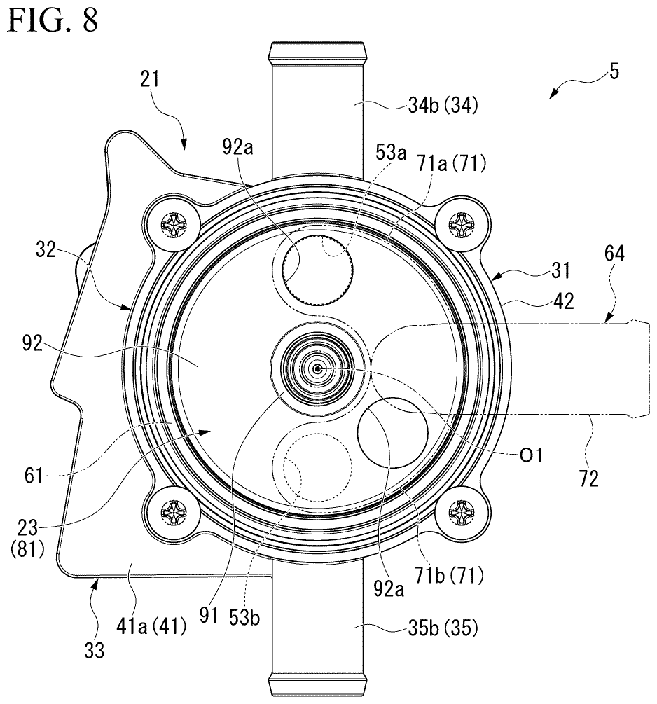

FIG. 7 is a bottom view of the cover 32. FIG. 8 is a plan view of the control valve 5 shown through the cover 32.
As shown in FIGS. 7 and 8, a flow inlet 65 is formed in the opposing wall 61. The flow inlet 65 penetrates the opposing wall 61 in the axial direction and extends in the circumferential direction. In the example shown in the drawing, the flow inlet 65 is formed in a C shape in plan view. Specifically, the flow inlet 65 wraps around one side of the central axis Ol in a second direction orthogonal to the first direction in the radial direction. One side end portion of the flow inlet 65 in the circumferential direction overlaps with the first flow outlet 53a in plan view. The other side end portion of the flow inlet 65 in the circumferential direction overlaps with the second flow outlet 53b in plan view.

As shown in FIGS. 4 and 5, the positioning portion 62 protrudes downward from an outer peripheral portion of the opposing wall 61. The positioning portion 62 is formed in a cylindrical shape disposed coaxially with the central axis O1. The positioning portion 62 is inserted inside the rotor housing portion 42 in a state in which the cover 32 is assembled to the base portion 33. The positioning portion 62 performs radial positioning of the cover 32 with respect to the base portion 33 by being in contact with the positioning surface 54 from a radially inner side.

The spring support portion 63 protrudes downward from a portion of the opposing wall 61 that is located radially inward of the positioning portion 62. The spring support portion 63 is formed in a cylindrical shape disposed coaxially with the central axis O1. The spring support portion 63 of the present embodiment is formed in a stepped shape with outer diameters that decrease toward the lower side. Specifically, the spring support portion 63 includes an axial support portion 63a and a radial support portion 63b.

The axial support portion 63a forms an upper end portion of the spring support portion 63. An outer diameter of the axial support portion 63a is greater than the inner diameters of the large-diameter portions 45a and 45c. A lower end surface of the axial support portion 63a is formed as a flat surface orthogonal to the axial direction.
The radial support portion 63b protrudes downward from the spring support portion 63. An outer diameter of the radial support portion 63b is smaller than the inner diameters of the large-diameter portions 45a and 45c and is greater than the inner diameter of the small-diameter portion 45b. Therefore, the radial support portion 63b faces the seal ring 46 in the axial direction. An inner diameter of the spring support portion 63 is uniformly formed over the entirety of the axial support portion 63a and the radial support portion 63b. In the example shown in the drawing, the inner diameter of the spring support portion 63 is equal to the inner diameter of the small-diameter portion 45b.

As shown in FIGS. 4, 5, and 7, the inflow port 64 connects the main flow path 10 and the control valve 5. The inflow port 64 includes a branch flow path 71 and a common flow path 72.
The branch flow path 71 covers the flow inlet 65 from the upper side and is formed in a dome shape bulging upward with respect to the opposing wall 61. The branch flow path 71 (each of branch portions 71a and 71b) is formed in a semi-circular shape in cross-sectional view orthogonal to an extension direction of the branch flow path 71.

In the example shown in the drawing, the branch flow path 71 has the same outer shape as the flow inlet 65 in plan view and is formed in a C shape extending in the circumferential direction. Specifically, the branch flow path 71 includes the first branch portion 71a that extends to one side from a central portion of the branch flow path 71 in the circumferential direction, and a second branch portion 71b that extends to the other side from the central portion of the branch flow path 71 in the circumferential direction. The branch flow path 71 is in communication with the flow inlet 65 over the entire length of the branch flow path 71 in the extension direction (circumferential direction). An opening area of a lower end opening portion of the branch flow path 71 is equal to an opening area of the flow inlet 65.

The common flow path 72 and the branch flow path 71 are located on the same plane orthogonal to the central axis O1. Specifically, the common flow path 72 protrudes from the central portion of the branch flow path 71 in the extension direction (circumferential direction) toward one side in the second direction. A proximal end portion of the common flow path 72 is in communication with the branch flow path 71. A distal end portion of the common flow path 72 is connected to the main flow path 10. The distal end portion of the common flow path 72 protrudes outward in the second direction with respect to the opposing wall 61. The cooling liquid that has flowed into the common flow path 72 from the main flow path 10 is distributed to the first branch portion 71a and the second branch portion 71b at the distal end portion of the common flow path 72.

The extension direction of the common flow path 72 is orthogonal to extension directions of the outflow ports 34 and 35 (the joint portions 34b and 35b). The common flow path 72 is formed in a circular shape in cross-sectional view orthogonal to the second direction. An amount of upward bulging of the common flow path 72 with respect to the opposing wall 61 is greater than an amount of upward bulging of the branch flow path 71 with respect to the opposing wall 61. Therefore, an upper end edge. of the common flow path 72 forms an uppermost end edge of the control valve 5.

Here, flow path cross-sectional areas (areas orthogonal to the extension directions) of the first branch portion 71a and the second branch portion 71b are uniformly formed over the entire length in the circumferential direction. It is preferable that the sum of the flow path cross-sectional areas of the first branch portion 7la and the second branch portion 71b is equal to or greater than a flow path cross-sectional area (area orthogonal to the extension direction) of the common flow path 72. However, the sum of the flow path cross-sectional areas of the first branch portion 71a and the second branch portion 71b may be smaller than the flow path cross-sectional area of the common flow path 72.

### Drive Unit 22>

As shown in FIG. 3, the drive unit 22 is configured to house a motor, a deceleration mechanism, a control board, and the like (not shown). The drive unit 22 is disposed below the mounting base 41. The drive unit 22 is assembled to the upright wall 41b in a state of being overlaid on the mounting base 41 in the axial direction. As shown in FIG. 6, the drive unit 22 includes an output shaft 22a that protrudes upward. The output shaft 22a is formed in a cylindrical shape disposed coaxially with the central axis O1.

### Rotor 23

As shown in FIGS. 3 and 4, the rotor 23 rotates inside the casing 21 to switch between communication and shut-off between the flow inlet 65 and the flow outlets 53a and 53b. Specifically, the rotor 23 includes a shaft portion 80 and a valve body 81. The rotor 23 is integrally formed, for example, by injection molding a resin material.

As shown in FIG. 6, the shaft portion 80 is disposed coaxially with the central axis O1. The shaft portion 80 penetrates the through-hole 45 in the axial direction. Specifically, the shaft portion 80 includes a coupling portion 80a that forms a lower end portion of the shaft portion 80, and a transmission portion 80b that is continuous with and extends upward from the coupling portion 80a.

The coupling portion 80a is formed in a solid form. A lower portion of the coupling portion 80a is fitted into the inside of the output shaft 22a. In the present embodiment, the coupling portion 80a is coupled to the output shaft 22a in a state in which a male spline formed on an outer peripheral surface of the coupling portion 80a and a female spline formed on an inner peripheral surface of the output shaft 22a are meshed with each other in the circumferential direction. Consequently, the coupling portion 80a is configured to rotate around the central axis O1 as the output shaft 22a rotates. An upper portion of the coupling portion 80a is disposed inside the first large-diameter portion 45a. A hollowed-out portion 80al that is recessed upward is formed in a lower end surface of the coupling portion 80a.

The transmission portion 80b is formed in a bottomed cylindrical shape (hollow shape) coaxial with the central axis O1. The inside of the transmission portion 80b forms a recessed portion 84 that is open upward. The transmission portion 80b includes a connection portion 85 and a peripheral wall portion 86.
The connection portion 85 is formed in a disc shape that is larger than an outer shape of the coupling portion 80a in plan view. The connection portion 85 is continuous with an upper end surface of the coupling portion 80a in a state of projecting radially outward beyond the outer peripheral surface of the coupling portion 80a. The connection portion 85 is disposed inside the small-diameter portion 45b. A hollowed-out portion 85a that is recessed downward is formed in an upper end surface of the connection portion 85. The hollowed-out portion 85a is in communication with the recessed portion 84 on the upper end surface of the connection portion 85. The hollowed-out portion 80a1 that is recessed upward is formed in the lower end surface of the coupling portion 80a. The coupling portion 80a may be formed in a hollow shape.

The peripheral wall portion 86 extends upward from an outer peripheral edge of the connection portion 85. The peripheral wall portion 86 is formed in a multi-stepped cylindrical shape with outer diameters that increase stepwise toward the upper side. Specifically, the peripheral wall portion 86 includes a small cylinder portion 86a, a projecting portion 86b, and a large cylinder portion 86c.
The small cylinder portion 86a is formed in a cylindrical shape having an outer diameter equal to an outer diameter of the connection portion 85. The small cylinder portion 86a is disposed inside the second large-diameter portion 45c. An inner peripheral surface of the seal ring 46 is in close contact with an outer peripheral surface of the small cylinder portion 86a. As a result, communication between the inside and the outside of the casing 21 through the through-hole 45 is shut off.

The projecting portion 86b projects radially outward from an upper end opening edge of the small cylinder portion 86a. The projecting portion 86b faces the second large-diameter portion 45c in the axial direction in a state in which at least a part of the projecting portion 86b protrudes into the rotor housing portion 42. Consequently, the seal ring 46 is restricted from coming out through an upper end opening portion of the second large-diameter portion 45c. An outer diameter of the projecting portion 86b is formed to be equal to or smaller than the inner diameter of the second large-diameter portion 45c.
The large cylinder portion 86c is formed in a cylindrical shape extending upward from an outer peripheral edge of the projecting portion 86b. The large cylinder portion 86c faces the radial support portion 63b in the axial direction.

As shown in FIGS. 4 and 5, the valve body 81 is formed in a truncated conical shape that is open upward. The valve body 81 is provided in the rotor housing portion 42 to be rotatable around the central axis Ol as the shaft portion 80 rotates. Specifically, the valve body 81 includes a valve bottom wall 91 and a sliding wall 92. A space surrounded by the valve bottom wall 91 and the sliding wall 92 in the valve body 81 forms an internal space K1 of the valve body 81. The internal space K1 is open upward. Therefore, the flow inlet 65 mentioned above is kept in constant communication with the internal space K1. The internal space K1 is in communication with the recessed portion 84 at a lower end portion.

The valve bottom wall 91 projects radially outward from a lower end portion of the large cylinder portion 86c. Therefore, the large cylinder portion 86c protrudes upward from the valve bottom wall 91 toward the internal space KI of the valve body 81. The valve bottom wall 91 faces the relief surface 51 with a gap therebetween in the axial direction. In the example shown in the drawing, a lower surface of the valve bottom wall 91 is located below an upper end of the transition surface 52. An upper surface of the valve bottom wall 91 is located above the upper end of the transition surface 52.

The sliding wall 92 is continuous with an outer peripheral edge of the valve bottom wall 91. The sliding wall 92 is formed in a tapered cylindrical shape that gradually increases in diameter toward the upper side. An upper end opening portion of the sliding wall 92 faces the opposing wall 61. The spring support portion 63 mentioned above extends into the internal space KI through the upper end opening portion of the sliding wall 92. In the example shown in the drawing, in the spring support portion 63, the entirety of the radial support portion 63b and a lower end portion of the axial support portion 63a extend into the internal space K1, At least a part of the spring support portion 63 may extend into the internal space K1 or may be located above the internal space K1.

In cross-sectional view along the axial direction, the sliding wall 92 linearly extends radially outward toward the upper side with a uniform thickness over the entire region in a vertical direction. An outer peripheral surface of the sliding wall 92 extends along the support surface 53. Therefore, in cross-sectional view along the axial direction, an angle θ2 (a taper angle shown in FIG. 6) formed by portions of the outer peripheral surface of the sliding wall 92 that face each other in the radial direction is equal to the taper angle θ1 of the support surface 53. The angle θ2 is preferably 90°<θ2<180° and more preferably 110°<θ2<160°. The outer peripheral surface of the sliding wall 92 slides on the support surface 53 as the valve body 81 rotates, The support surface 53 rotatably supports the valve body 81 via the sliding wall 92. An upper end edge of the sliding wall 92 is in proximity to the positioning surface 54 on the radially inner side.

A communication port 92a that penetrates the sliding wall 92 in the axial direction is formed in the sliding wall 92, In a case where at least a part of the communication port 92a and at least a part of either the flow outlet 53a or 53b overlap with each other in plan view, the valve body 81 brings either the flow outlet 53a or 53b and the internal space K1 into communication with each other through the communication port 92a. In a case where the communication port 92a does not overlap with either the flow outlet 53a or 53b, communication between the internal space K1 and the flow outlets 53a and 53b is shut off by the valve body 81. In the present embodiment, two communication ports 92a are formed at an interval in the circumferential direction. In the example shown in the drawing, among conjugate angles formed by a straight line connecting the central axis O1 and each of the communication ports 92a, an angle on an obtuse angle side is greater than 90° and less than 180°. However, the number of communication ports 92a, the interval between the communication ports 92a adjacent to each other, and the like can be changed as appropriate.

### Biasing Member 24

The biasing member 24 is, for example, a flat plate-shaped coil spring. The biasing member 24 is sandwiched between the valve bottom wall 91 and the axial support portion 63a in a state of being disposed coaxially with the central axis O1. The entirety of the biasing member 24 is located in the internal space K1. The biasing member 24 is provided inside the rotor 23. The biasing member 24 need only be provided at least inside the rotor 23.

The biasing member 24 biases the valve body 81 downward. The sliding wall 92 is pressed against the support surface 53 by the biasing force of the biasing member 24. The radial support portion 63b is inserted into an inner side of an upper end portion of the biasing member 24. The biasing member 24 is restricted from moving in the radial direction with respect to the casing 21 by being in contact with the radial support portion 63b from the radial direction. The large cylinder portion 86c is inserted into an inner side of a lower end portion of the biasing member 24. The biasing member 24 is restricted from moving in the radial direction with respect to the casing 21 by being in contact with the large cylinder portion 86c from the radial direction. In the present embodiment, a configuration has been described in which the biasing member 24 is indirectly supported by the opposing wall 61 via the spring support portion 63, but the present disclosure is not limited to this configuration. The biasing member 24 may be directly supported by the opposing wall 61.

### Method of Operating Control Valve 5

Next, a method of operating the control valve 5 will be described. p1 As shown in FIG. 1, in the main flow path 10, the cooling liquid fed by the water pump 4 undergoes heat exchange in the heat generating portion 2 and then flows toward the control valve 5. As shown in FIG. 4, the cooling liquid that has passed through the heat generating portion 2 in the main flow path 10 passes through the inflow port 64 and then flows into the internal space K1 through the flow inlet 65. As a result, the entire region inside the base portion 33 is filled with the cooling liquid.

Subsequently, a method of distributing the cooling liquid in the control valve 5 will be described. p1 In a case where the communication port 92a and any one of the flow outlets 53a and 53b do not overlap with each other, the communication between the internal space K1 and the flow outlets 53a and 53b (the outflow ports 34 and 35) through the communication port 92a is shut off (shut-off state). In the shut-off state, the flow of the cooling liquid from the internal space K1 to the flow outlets 53a and 53b through the communication port 92a is restricted.

For example, in a case where the cooling liquid is to be supplied to the radiator 8, the communication port 92a is brought into communication with the first flow outlet 53a as shown in FIG. 8. Specifically, the drive unit 22 is driven to rotate the rotor 23 around the central axis O1. In this case, the rotor 23 rotates around the central axis O1 while the outer peripheral surface of the sliding wall 92 slides on the support surface 53. Then, at least a part of the communication port 92a and at least a part of the first flow outlet 53a overlap with each other, whereby the communication port 92a and the first flow outlet 53a communicate with each other (first communication state). In the first communication state, the cooling liquid in the internal space KI flows out through the communication port 92a. The cooling liquid that has flowed out from the internal space K1 passes through the first flow outlet 53a, and is then distributed to the radiator flow path 11 through the first outflow port 34. The cooling liquid that has been distributed to the radiator flow path 11 passes through the radiator 8, is then returned to the main flow path 10, and flows into the control valve 5 again.

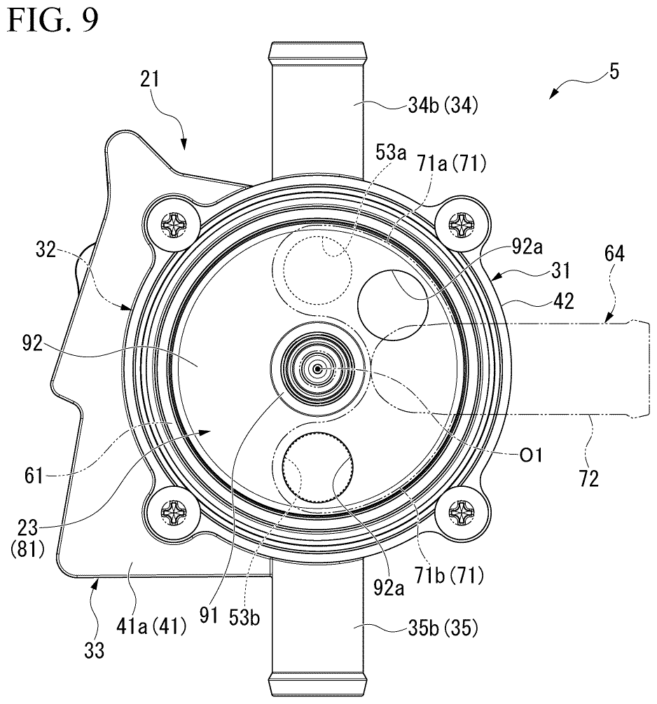

In a case where the cooling liquid is to be supplied to the heater core 9, the communication port 92a is brought into communication with the second flow outlet 53b as shown in FIG. 9 by using the same method as the method mentioned above (second communication state). Consequently, the cooling liquid that has flowed out from the internal space K1 passes through the second flow outlet 53b, and is then distributed to the air conditioning flow path 12 through the second outflow port 35.
In this manner, in the control valve 5 of the present embodiment, the communication and the shut-off between the internal space K1 and the flow outlets 53a and 53b through the communication port 92a are switched in accordance with the rotation position of the rotor 23. As a result, it is possible to distribute the cooling liquid to the desired flow path.

In the control valve 5 of the present embodiment, a configuration has been employed in which the rotor 23 includes the valve body 81 having an outer diameter that gradually increases toward the upper side from the shaft portion 80, and the outer peripheral surface of the valve body 81 is slidably supported by the casing 21.
According to this configuration, since the valve body 81 is directly supported by the casing 21, it is not necessary to separately provide a sealing member or a bearing. Therefore, it is possible to achieve reductions in the number of components and assembly man-hours, size reduction of the control valve 5, and cost reduction.
Since the valve body 81 is formed in a tapered shape, in a case where the outer diameter of the rotor 23 expands or contracts due to heat, the rotor 23 is displaced in the axial direction on the support surface 53 in response to an increase or decrease in the outer diameter. Therefore, the valve body 81 is stably supported on the support surface 53 regardless of the expansion and contraction change of the rotor 23. Accordingly, the operational stability of the control valve 5 can be ensured.

In particular, in the control valve 5 of the present embodiment, a configuration has been employed in which the biasing member (first biasing member) 24 is provided inside the rotor 23.
According to this configuration, since the outer peripheral surface of the valve body 81 (sliding wall 92) can be pressed against the support surface 53, sealing performance between the outer peripheral surface of the valve body 81 and the support surface 53 can be ensured. As a result, it is possible to suppress unexpected leakage of the cooling liquid from the gap between the outer peripheral surface of the valve body 81 and the support surface 53, and to allow a desired flow rate of the cooling liquid to flow. In addition, since the biasing member 24 is provided inside the rotor 23, it is possible to achieve size reduction of the control valve 5 in the axial direction as compared with a case where the biasing member is provided outside the rotor 23.

In the control valve 5 of the present embodiment, a configuration has been employed in which the biasing member 24 is a coil spring that is interposed between the opposing wall 61 and the inner surface of the rotor 23 through the internal space K1.
According to this configuration, the outer peripheral surface of the valve body 81 can be stably pressed against the support surface 53. Consequently, sealing performance between the outer peripheral surface of the valve body 81 and the support surface 53 can be ensured.
Moreover, in the control valve 5 of the present embodiment, by using the flat plate-shaped coil spring, it is possible to reduce a frictional force generated in a case where the biasing member 24 and at least any one of the valve bottom wall 91 and the axial support portion 63a rotate relative to each other during the rotation of the rotor 23. As a result, the durability can be improved.

In the control valve 5 of the present embodiment, a configuration has been employed in which the valve body 81 includes the valve bottom wall 91 that projects in the radial direction from the shaft portion 80, and the lower end portion (first side end portion) of the biasing member 24 is supported by the valve bottom wall 91.
According to this configuration, the lower end portion of the biasing member 24 can be stably supported.

In the control valve 5 of the present embodiment, a configuration has been employed in which the shaft portion 80 includes the large cylinder portion (first support portion) 86c that protrudes upward beyond the valve bottom wall 91 and that supports the lower end portion of the biasing member 24 in the radial direction.
According to this configuration, the movement of the biasing member 24 in the radial direction with respect to the valve body 81 can be restricted. As a result, a stable biasing force can be exhibited over a long period of time.

In the control valve 5 of the present embodiment, a configuration has been employed in which the opposing wall 61 is provided with the radial support portion 63b that extends into the internal space K1 through the upper end opening portion of the valve body 81 and that supports the upper end portion (second side end portion) of the biasing member 24 in the radial direction.
According to this configuration, the movement of the biasing member 24 in the radial direction with respect to the opposing wall 61 (cover 32) can be restricted, As a result, a stable biasing force can be exhibited over a long period of time.
In the control valve 5 of the present embodiment, a configuration has been employed in which the shaft portion 80 is formed with the recessed portion 84 that is open upward and that communicates with the internal space K1.

According to this configuration, it is possible to suppress an increase in the wall thickness of the shaft portion 80 when forming the rotor 23 by injection molding. Consequently, it is possible to suppress sink marks and the like in the shaft portion 80 and to mold the shaft portion 80 with high accuracy. As a result, the rotor 23 can be stably rotated. Since the recessed portion 84 is formed to be recessed with respect to the internal space K1, the recessed portion 84 serves as a stagnation point inside the rotor 23. Therefore, for example, contaminants and the like in the cooling liquid can be captured in the recessed portion 84. As a result, it is possible to suppress biting of contaminants and the like between the outer peripheral surface of the valve body 81 and the support surface 53.

In the control valve 5 of the present embodiment, a configuration has been employed in which the recessed portion 84 is formed in at least the transmission portion 80b.
According to this configuration, it is possible to suppress sink marks and the like in the transmission portion 80b and to mold the transmission portion 80b with high accuracy. Consequently, sealing performance between the seal ring 46 and the transmission portion 80b can be improved.
Moreover, in the present embodiment, since the recessed portion 84 is located inside the large cylinder portion 86c, the large cylinder portion 86c can be formed with high accuracy. As a result, the biasing member 24 can be stably supported in the radial direction.
In the present embodiment, since the hollowed-out portions 80a1 and 85a are formed in the coupling portion 80a, the coupling portion 80a can be molded with high accuracy. As a result, the coupling portion 80a and the drive unit 22 (output shaft 22a) can be firmly coupled to each other.

In the first embodiment, a configuration has been described in which the large cylinder portion 86c as the first support portion supports the lower end portion of the biasing member 24 from the radially outer side, but the present disclosure is not limited to this configuration. The first support portion may support the lower end portion of the biasing member 24 from the radially inner side.

In the first embodiment, a configuration has been described in which the radial support portion 63b as the second support portion supports the upper end portion of the biasing member 24 from the radially inner side, but the present disclosure is not limited to this configuration. The second support portion may support the upper end portion of the biasing member 24 from the radially outer side.

### Second Embodiment

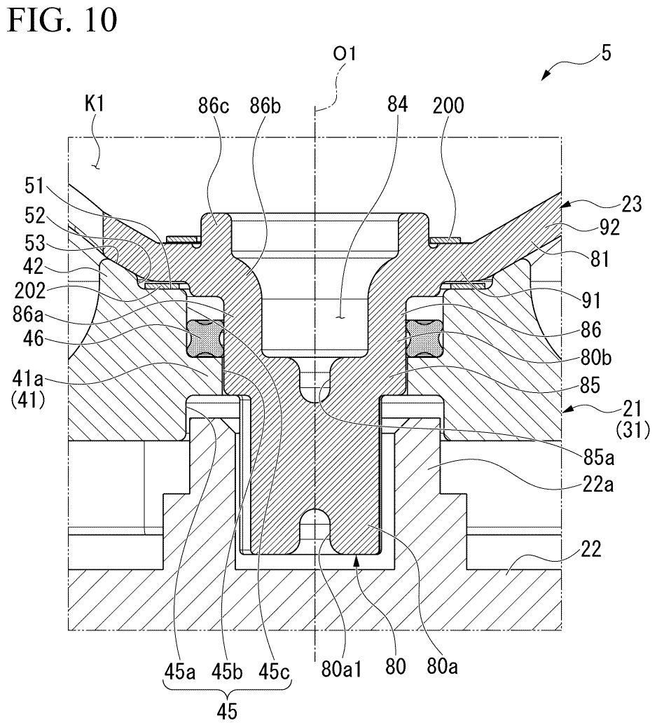

FIG. 10 is an enlarged cross-sectional view according to a second embodiment that corresponds to FIG. 6.
As shown in FIG. 10, the control valve 5 of the present embodiment includes a first biasing member 200 provided inside the rotor 23 and a second biasing member 202 provided in the casing main body 31.

The first biasing member 200 is, for example, a ferromagnetic member (one member) such as iron. In the example shown in the drawing, the first biasing member 200 is formed in an annular shape coaxial with the central axis O1. The first biasing member 200 is disposed on the valve bottom wall 91 in a state in which the large cylinder portion 86c is inserted. The first biasing member 200 is provided inside the rotor 23 (internal space K1). The first biasing member 200 may be embedded in the rotor 23 by insert molding or the like.

The second biasing member 202 is, for example, a permanent magnet (the other member). The second biasing member 202 is housed in an annular space K2 surrounded by the relief surface 51 and the transition surface 52 in the casing main body 31. The second biasing member 202 faces the first biasing member 200 in the axial direction with the valve bottom wall 91 sandwiched therebetween. The first biasing member 200 biases the rotor 23 downward by being attracted by a magnetic attraction force generated between the first biasing member 200 and the second biasing member 202. Consequently, the sliding wall 92 is pressed against the support surface 53 by the biasing force (magnetic attraction force) generated between the first biasing member 200 and the second biasing member 202. The second biasing member 202 may be embedded in the casing main body 31 by insert molding or the like. The first biasing member 200 and the second biasing member 202 can be disposed at any position as long as the magnetic attraction force is generated therebetween.

In the control valve 5 of the present embodiment, the valve body 81 is pressed against the support surface 53 by the biasing force generated between the first biasing member 200 and the second biasing member 202, whereby sealing performance between the outer peripheral surface of the valve body 81 and the support surface 53 can be ensured.
Moreover, since the biasing member does not cross the inner space K1 of the rotor 23 in the axial direction, pressure loss in the internal space K1 can be reduced.

In the second embodiment, a case has been described in which the first biasing member 200 is a ferromagnetic member and the second biasing member 202 is a permanent magnet, but the present disclosure is not limited to this configuration. The first biasing member 200 may be a permanent magnet, and the second biasing member 202 may be a ferromagnetic member.
In the second embodiment, a configuration has been described in which the valve body 81 is biased toward the support surface 53 by the magnetic attraction force between the first biasing member 200 and the second biasing member 202, but the present disclosure is not limited to this configuration. For example, both the first biasing member 200 and the second biasing member 202 may be permanent magnets, and the valve body 81 may be biased toward the support surface 53 by a repulsive force generated between the first biasing member 200 and the second biasing member 202.

### Other Modification Examples

Although the preferred embodiments of the present disclosure have been described above, the present disclosure is not limited to these embodiments. Additions, omissions, replacements, and other modifications in the configurations can be made within the scope of the present disclosure without departing from its gist. The present disclosure is not limited by the above description, and is limited only by the appended claims.
For example, in the embodiments mentioned above, a configuration has been described in which the control valve 5 is mounted in the cooling system 1 of the vehicle, but the present disclosure is not limited to this configuration, and the control valve 5 may be mounted in other systems.
In the embodiments mentioned above, a configuration has been described in which the two flow outlets 53a and 53b are provided, but the present disclosure is not limited to this configuration. At least one flow outlet need only be provided.
In the embodiments mentioned above, a configuration has been described in which the outflow ports 34 and 35 are integrally formed with the base portion 33, but the present disclosure is not limited to this configuration. The outflow ports 34 and 35 may be formed separately from the base portion 33.

In the embodiments mentioned above, a configuration has been described in which the flow inlet 65 is kept in constant communication with the internal space K1, but the present disclosure is not limited to this configuration. For the flow inlet 65, a configuration may also be employed in which the communication with and the shut-off from the internal space K1 are switched in response to the rotation of the rotor 23. The control valve according to the present disclosure need only have a configuration in which the communication and the shut-off between the internal space and at least one of the flow inlet and the flow outlet are switched through the communication port formed in the valve body in accordance with the rotation position of the valve body.
In the embodiments mentioned above, a configuration has been described in which the valve body 81 linearly extends in cross-sectional view, but the present disclosure is not limited to this configuration. A configuration may also be employed in which the valve body 81 extends in an arc shape in cross-sectional view,

In the embodiments mentioned above, a configuration has been described in which the biasing member 24 is provided in the internal space KI, but the present disclosure is not limited to this configuration. The position of the biasing member can be changed as appropriate as long as the biasing member is configured to press the valve body 81 against the support surface 53. The biasing member is not an essential configuration.
In the embodiments mentioned above, a configuration has been described in which the flow inlet 65 is formed in the cover 32, but the present disclosure is not limited to this configuration. The flow inlet may be formed in the casing main body 31. The number of flow inlets is not limited to one, and a plurality of flow inlets may be provided.

In the embodiments mentioned above, a configuration has been described in which the inflow port 64 extends in the radial direction (second direction) in a state of bulging upward from the opposing wall 61, but the present disclosure is not limited to this configuration. A configuration may also be employed in which the inflow port 64 extends only in the axial direction from the opposing wall 61.
In the embodiments mentioned above, a configuration has been described in which the first flow path of the inflow port 64 is the branch flow path 71, but the present disclosure is not limited to this configuration. The shape of the first flow path can be changed as appropriate as long as it is in communication with the flow inlet 65.
In the embodiments mentioned above, a configuration has been described in which the first flow path (branch flow path 71) communicates with the flow inlet 65 over the entire length, but the present disclosure is not limited to this configuration. At least a part of the first flow path in the extension direction need only be in communication with the flow inlet 65.

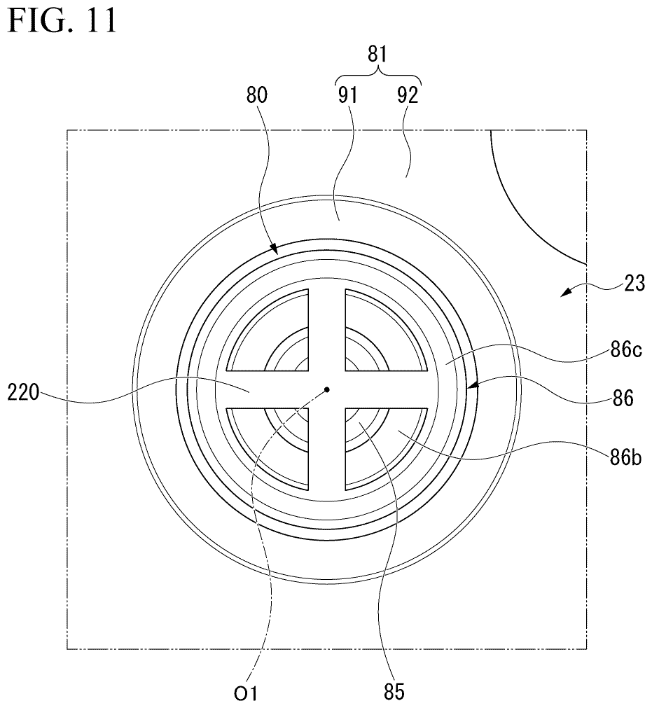

In the embodiments mentioned above, a configuration has been described in which the recessed portion 84 and the hollowed-out portions 80al and 85a are formed in the shaft portion 80, but the present disclosure is not limited to this configuration. The recessed portion 84 and the hollowed-out portions 80al and 85a are not essential configurations. For example, as shown in FIG. 11, a rib 220 or the like that bridges inner peripheral surfaces of the peripheral wall portion 86 in the radial direction may be provided in the recessed portion 84.
In the embodiments mentioned above, a configuration has been described in which the biasing member 24 is interposed between the valve bottom wall 91 and the opposing wall 61 (axial support portion 63a), but the present disclosure is not limited to this configuration. The biasing member 24 may be supported by, for example, the sliding wall 92 or the shaft portion 80.

In addition, within the scope of the present disclosure without departing from its gist, it is possible to appropriately replace the constituent elements in the embodiments mentioned above with well-known constituent elements, and the modification examples mentioned above may be combined as appropriate.

### REFERENCE SIGNS LIST

5 Control valve
21 Casing
23 Rotor
24 Biasing member (first biasing member)
45 Through-hole
46 Seal ring
53 Support surface
53a First flow outlet (flow outlet)
53b Second flow outlet (flow outlet)
61 Opposing wall
63b Radial support portion (second support portion)
65 flow inlet
80 Shaft portion
80a Coupling portion
80b Transmission portion
81 Valve body
84 Recessed portion
91 Valve bottom wall
92 Sliding wall
92a Communication port
200 First biasing member
202 Second biasing member
K1 Internal space

1. A control valve comprising:
a casing in which a flow inlet through which a fluid flows in from an outside and a flow outlet through which the fluid flows out to the outside are formed; and
a rotor including
a shaft portion located on a first side in an axial direction and rotatably supported by the casing, and
a valve body having an outer diameter that gradually increases toward a second side in the axial direction from the shaft portion and forming an internal space that is open toward the second side in the axial direction,
wherein the rotor switches between communication and shut-off between the internal space and at least one of the flow inlet and the flow outlet, through a communication port formed in the valve body, in accordance with a rotation position of the rotor, in a state in which an outer peripheral surface of the valve body is supported to be slidable on a support surface formed on the casing, and
a first biasing member configured to bias the rotor toward the first side in the axial direction is provided inside the rotor.

2. The control valve according to claim 1,
wherein the casing includes an opposing wall facing a second side opening portion of the valve body in the axial direction,
the first biasing member is a coil spring extending in the axial direction, and
the first biasing member is interposed between the opposing wall and an inner surface of the rotor through the internal space.

3. The control valve according to claim 2,
wherein the valve body includes
a valve bottom wall projecting from the shaft portion in a radial direction intersecting the axial direction, and
a sliding wall having an outer diameter that gradually increases toward the second side in the axial direction, the sliding wall being continuous with an outer peripheral edge of the valve bottom wall, and
a first side end portion of the first biasing member in the axial direction is supported by the valve bottom wall.

4. The control valve according to claim 3,
wherein the shaft portion includes a first support portion protruding to the second side in the axial direction beyond the valve bottom wall and configured to support, in the radial direction intersecting the axial direction, the first side end portion of the first biasing member in the axial direction.

5. The control valve according to claim 2,
wherein the opposing wall is provided with a second support portion extending into the internal space through the second side opening portion of the valve body and configured to support, in the radial direction intersecting the axial direction, a second side end portion of the first biasing member in the axial direction.

6. The control valve according to claim 1,
wherein the shaft portion is formed with a recessed portion communicating with the internal space, the recessed portion being open toward the second side in the axial direction.

7. The control valve according to claim 6,
wherein the shaft portion includes
a transmission portion penetrating the casing in the axial direction through a through-hole formed in the casing, and
a coupling portion continuous with the transmission portion on the first side in the axial direction and coupled to an actuator,
a seal ring configured to seal an inside and an outside of the casing is formed between the transmission portion and an inner peripheral surface of the through-hole, and
the recessed portion is formed in at least the transmission portion.

8. The control valve according to claim 1,
wherein the first biasing member is one member of a magnet and a ferromagnetic member attractable to the magnet, and
the casing is provided with a second biasing member formed of an other member of the magnet and the ferromagnetic member.

9. The control valve according to claim 1,
wherein the casing includes
a rotor housing portion including the support surface having an inner diameter that decreases toward the first side from the second side in the axial direction, the rotor housing portion being open to the second side in the axial direction, and
a cover configured to close a second side opening portion of the rotor housing portion in the axial direction, and
the first flow outlet is formed to penetrate the support surface in the axial direction.

10. The control valve according to claim 9,
wherein the rotor housing portion is integrally formed with a first outflow port communicating with the first flow outlet and extending toward the first side in the axial direction.

11. The control valve according to claim 10,
wherein a downstream end portion of the first outflow port extends outward in a radial direction intersecting the axial direction.

12. The control valve according to claim 11,
wherein a second flow outlet through which the fluid flows out to the outside is open at a position in the support surface that faces the first flow outlet in the radial direction intersecting the axial direction,
the rotor housing portion is provided with a second outflow port communicating with the second flow outlet and extending toward a side opposite to the first outflow port in the radial direction, and
when a direction in which the first flow outlet and the second flow outlet face each other is defined as an opposing direction in the radial direction,
the casing includes an inflow port extending in a direction intersecting the opposing direction in the radial direction and communicating with the flow inlet.
